(19) United States
(12) Patent Application Publication
(10) Pub. No.: US 2015/0348004 A1
(43) Pub. Date: Dec. 3, 2015

(54) MOBILE MERCHANT CHECK-IN AT A USER'S HOME LOCATION

(71) Applicant: EBAY INC., San Jose, CA (US)

(72) Inventor: David Edward Eramian, San Jose, CA (US)

(21) Appl. No.: 14/292,219

(22) Filed: May 30, 2014

(51) Int. Cl. G06Q 20/32; G06Q 20/10; G06F 17/30

(52) U.S. Cl. CPC G06Q 20/3224; G06F 17/30864; G06Q 20/102

(57) ABSTRACT

There are provided systems and methods for mobile merchant check-in at a user's home location. A user may set up a wireless beacon at a location of the user, such as a home location. The wireless beacon may provide check-in services to a mobile merchant arriving at the location, such a delivery person for items or services. The mobile merchant may be checked-in through a device and may push a payment total to the user's device. Therefore, the user's device may populate the payment amount for delivery of the items or services. The user may utilize their device to generate a payment request by provide a payment instrument for the payment amount. Additionally, the user may complete the payment request over a network connection with the wireless beacon. Thus, the user does not need to be at the home location when providing payment to the mobile merchant.

### TECHNICAL FIELD

The present application generally relates to mobile merchant check-in at a user's home location and more specifically to providing a wireless beacon that checks-in a mobile merchant, such as a delivery person, when the mobile merchant arrives at a user's home so that the mobile merchant and the user may complete a transaction.

### BACKGROUND

Users (e.g., a merchant's customer) may order items to home locations, such as packages, food items, services, or other deliverable items. Commonly, customers order pizza or other take-out food to their home addresses. To provide payment for home delivery of items and/or services from a merchant using a payment card (such as a credit card), customers typically have to provide payment card information when ordering the items/services for processing prior to delivery of the items. However, this potentially exposes the customer to risk of fraud or theft. For example, the customer may be required to provide a payment card number, which may be difficult or impossible in crowded situations. Other times, customers may utilize a device to order and check-out for the deliverable items/services. Often check-out requires the consumer to establish a new user account, or remember a login for a past user account, as well as enter payment information. Payment entered to merchant websites may be become compromised and also can be a hassle for the customer to enter. Moreover, the customer is required to remain at provided location to sign for the payment card and provide a tip to the delivery man. Customers are also given the option of paying in cash; however, this requires the customer to have cash on hand. Additionally, certain consumers may wish to leave the provided location after ordering, for example, when a customer has a babysitter watch their kids. This may place a burden on the two parties to provide payment to the delivery person, such as through leaving cash or having the person remaining at the provided location pay the delivery person with their own funds. Furthermore, there may be instances when the customer does not want to open the door to make the payment due to inconvenience or safety.

### BRIEF DESCRIPTION OF THE DRAWINGS

FIG. 1 is a block diagram of a networked system suitable for implementing the processes described herein, according to an embodiment;

FIG. 2 is an exemplary system environment displaying a mobile merchant checking in to a home location of a user, according to an embodiment;

FIG. 3 is an exemplary system environment showing display screens of a user device and a merchant device after check-in at a home location of a user, according to an embodiment;

FIG. 4 is a flowchart of an exemplary process by a server for mobile merchant check-in at a user's home location, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations may provide short range wireless communications with a device, such as through Bluetooth Low Energy (BLE) beacon communications, LTE Direct beacon communications, and WiFI beacon or Internet router communications. These beacons may be set up at a location and communicate with devices to alert users of check-in services through their device. The beacons may provide additional functionality, such as establishing a connection with a server entity to complete transactions, including check-in services. The beacons may provide communications to the devices directly, including information stored in the beacons. The beacons may also provide communication with a device attached to, or in communication with, the beacon, such as another device of another user.

A user, such as a consumer, may offer check-in services to mobile merchants, such as delivery people, to facilitate payment for delivery services to a home location of the user (which can include a house, apartment, office, or other location the user typically accepts deliveries). The user may utilize a short range wireless beacon at a location corresponding to the user to communicate with a device of the mobile merchant. For example, the short range wireless beacon may be established at a home location of the user. The beacon may employ BLE communications that emit a signal receivable by the mobile merchant's device. The communication may include an identifier for the beacon, the user, and/or a payment provider/merchant. The mobile merchant's device may be set up to passively monitor for BLE communications. When the device detects the signal and verifies the one or more identifiers, both the device and the beacon may ramp up in power and establish a connection, where the connection may further enable the device to communicate with the payment provider or merchant server. The beacon may be connected to a networked device at the home location of the user, or the beacon may include network functionality to communicate with other devices and/or servers, including a user device of the user corresponding to the home location. Thus, the beacon enables the mobile merchant's device to complete a check-in at the home location of the user. The check-in may be completed automatically when the mobile merchant's device is in range of the beacon, or may be completed after prompting the mobile merchant to check-in when the mobile merchant's device is in range of the beacon. The user may limit the range of the beacon to a distance near the home location or front door/entryway of the home location.

Once a check-in of the mobile merchant is completed at the home location, the mobile merchant may push a payment amount to the user device of the user. The payment amount may correspond to a delivery amount (e.g., cost of the deliverable item/service, delivery cost, tax, etc.). In certain implementations, the payment amount may further include a tip amount set in advance by the mobile merchant or the user, such as when placing the order. However, in other embodiments, the tip amount may be left blank to allow for the user to later enter a tip amount. The payment amount may be automatically pushed to the beacon, and thus the device, when the mobile merchant checks-in to the beacon at the location corresponding to the user, or may be pushed to the beacon after input by the mobile merchant.

The user may view the payment amount on their user device and generate a payment request. If tip has not been previously added, the user may also add a tip amount to increase the payment amount in the payment request. The payment request may include an identifier for a payment account with a payment provider to complete the payment request, or may include financial information for the user, for example, payment cards stored by the user device or input by the user. The payment request may be transmitted to the payment provider and/or merchant for completion. Once completed, the mobile merchant may be notified of payment so that the mobile merchant may render the items/services to the user.

In various embodiments, the user may not be at the home location when the mobile merchant arrives. However, using a network connection, the wireless beacon may update the user of the arrival of the mobile merchant. The user may either request that the mobile merchant wait, return later, or leave the delivered items at the home location. Thus, the user may provide delivery instructions to the mobile merchant using the beacon at the home location. In other embodiments, the user may alert another user at the home location of the arrival of the mobile merchant so that the other user may receive the items/services delivered by the mobile merchant. If the other user is checked-in to or in communication with the beacon, the beacon may also alert the other user of the presence of the mobile merchant.

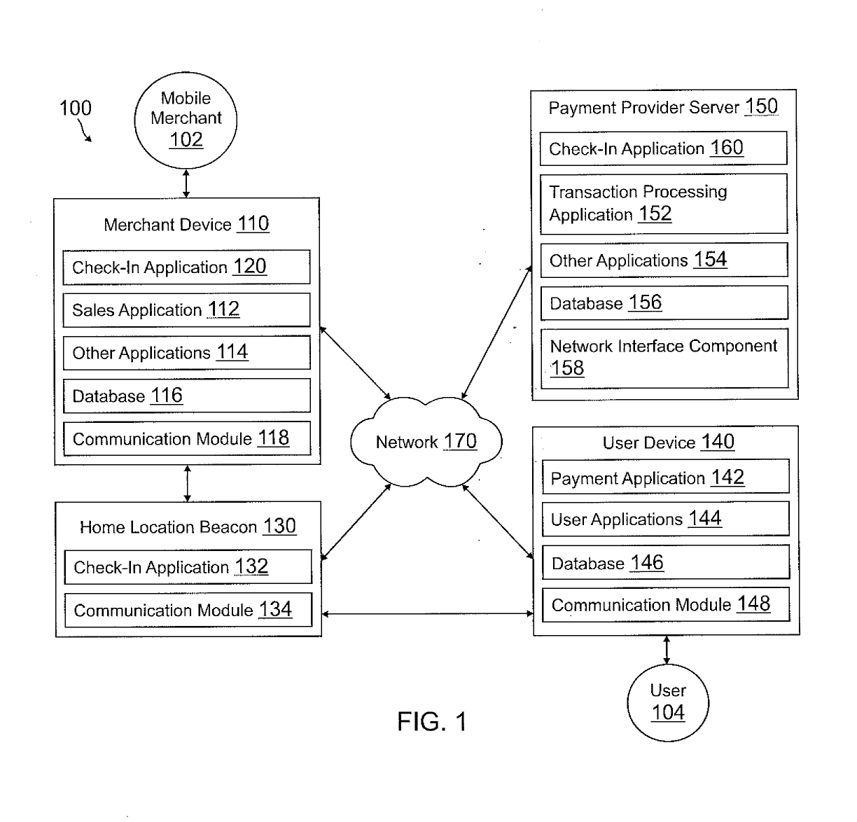

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a mobile merchant 102, a user 104 a merchant device 110, a home location beacon 130, a user device 140, and payment provider server 150 in communication over a network 170. Mobile merchant 102, such as a delivery person for a merchant or a merchant having delivery services, may utilize merchant device 110 to check-in to a location corresponding to user 104 through home location beacon 130 using payment provider server 150. Thus, home location beacon 130 may be located at a home, office, or other place where user 104 is located at or associated with. Once checked-in with payment provider server 150, mobile merchant 102 may be associated with the location of user 104. Further, mobile merchant 102 may utilize merchant device 110 to push payment information to user device 140. User 104 may then utilize user device 140 and payment provider server 150 to complete payment for items and/or services delivered by mobile merchant 102.

Merchant device 110, home location beacon 130, user device 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Merchant device 110 may be implemented using any appropriate hardware and software configured for wired and/or wireless communication with home location beacon 130, user device 140, and/or payment provider server 150. For example, in one embodiment, merchant device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an PAD® from APPLE®. Although a merchant device is shown, the merchant device may be managed or controlled by any suitable processing device. Although only one merchant device is shown, a plurality of merchant devices may function similarly.

Merchant device 110 of FIG. 1 contains a check-in application 120, a sales application 112, other applications 114, a database 116, and a communication module 118. Check-in application 120, sales application 112, and other applications 114 may correspond to processes, procedures, and/or applications executable by a hardware processor, for example, a software program. In other embodiments, merchant device 110 may include additional or different software as required.

Check-in application 120 may be used by mobile merchant 102 of merchant device 110 to establish a connection between merchant device 110, user device 140, and/or payment provider server 150 through home location beacon 130. Check-in application 120 may correspond to a specific application utilized by merchant device 110 with payment provider server 150 to complete a check-in for a location corresponding to home location beacon 130. The check-in with payment provider server 150 may correspond to a process to log in to a user account of mobile merchant 102 with payment provider server 150. In other embodiments, the check-in may provide and/or verify the identity of mobile merchant 102, including transmission of an identifier for mobile merchant 102 and/or merchant device 110. The check-in may be completed over network 170 with payment provider server 150. In such embodiments, check-in application 120 may correspond more generally to a browser application configured to communicate with payment provider server 150.

Check-in application 120 may also correspond to an application available over the Internet for download from payment provider server 150. Check-in application 120 may receive short range wireless communications with home location beacon 130 at a location corresponding to user 104 and complete a check-in process with payment provider server 150 that associates mobile merchant 102 with the location corresponding to user 104. For example, the location of user 104 may correspond to a home location (or office, business, etc. location) where home location beacon 130 is set up to communicate with merchant device 110 when merchant device 110 is in proximity to the home location. In such an example, home location beacon 130 may be set up at an entryway, driveway, door, or other area of the home location to provide communications with merchant device 110 when merchant device 110 arrives at the home location. Thus, check-in application 120 may complete the check-in process with payment provider server 150 through home location beacon 130 when mobile merchant 102 is at the home location, thereby associating mobile merchant 102 with the home location of user 104.

Check-in application 120 may execute in the background of an operating system of merchant device 110 and be configured to establish connections, using communication module 118 of merchant device 110, with home location beacon 130 at a location corresponding to user 104. The connection may be established with or without user input from mobile merchant 102. For example, home location beacon 130 may broadcast a token, such as a universally unique identifier (UUID), for reception by check-in application 120, as will be explained in more detail herein. Check-in application 120 may utilize communication module 118 of merchant device 110 to receive the token from home location beacon 130. If check-in application 120 acknowledges the UUID as identifying home location beacon 130, user device 140, and/or payment provider server 150 (e.g., if check-in application 120 determines the UUID corresponds to a request to complete a check-in), check-in application 120 may transmit an identifier corresponding to mobile merchant 102 and/or merchant device 110 back to home location beacon 130. Check-in application 120 may utilize communication module 118 of merchant device 110 to communicate with home location beacon 130 (e.g., over near field communication, Bluetooth, Bluetooth Low Energy, radio, infrared, or other connection). The identifier from merchant device 110 may include, be transmitted with, concatenated with, or otherwise bundled with the identifier received from home location beacon 130.

Once a connection is established with home location beacon 130, merchant device 110 may be checked-in with payment provider server 150 if mobile merchant 102 has not previously been checked-in. The check-in process may then associate mobile merchant 102 with home location beacon 130 used to check-in mobile merchant 102. For example, user 104 may previously have registered home location beacon 130 as belonging to user 104 and/or as being located at a location corresponding to user 104 (e.g., at a home location of user 104). Thus, payment provider server 150 is informed that mobile merchant 102 is in proximity to the location corresponding to user 104 because mobile merchant 102 connected to home location beacon 130 using merchant device 110. Thus, where home location beacon 130 corresponds generally to the home location of user 104, mobile merchant 102 may be associated with the home location. In other embodiments, home location beacon 130 may be established at a workplace, business, or other location associated with user 104.

Check-in application 120 may also transmit and/or receive information. For example, check-in application 120 may receive information for user 104, including an address, unit number, name, and/or payment instructions corresponding to user 104. The information may assist mobile merchant 102 in locating user 104 and transmitting a payment amount to user 104. The payment amount may correspond to an amount user 104 is required to pay for the items and/or services of mobile merchant 102, as will be explained in more detail herein. Merchant device 110 may utilize communication module 118 to receive the aforementioned information for display to mobile merchant 102 in an application interface of check-in application 120.

Check-in application 120 may utilize communication module 118 to pass information to home location beacon 130, user device 140, and/or payment provider server 150. For example, information passed to home location beacon 130 and/or user device 140 may include information for user 104, such as a name or other identification information for mobile merchant 102, ordered or available items for mobile merchant 102, and/or other information related to mobile merchant 102. As previously discussed, check-in application 120 may provide check-in information to payment provider server 150 directly or through home location beacon 130. Additionally, check-in application 120 may also provide payment provider server 150 with information for mobile merchant 102 and/or merchant device 110, including identifiers, user/financial accounts with payment provider server 150, transaction histories between mobile merchant 102 and user 104, and/or other payment information. Sales application 112 may also pass the aforementioned information to home location beacon 130, user device 140, and/or payment provider server 150.

Sales application 112 may be used, for example, to provide a convenient interface to permit mobile merchant 102 to enter, view, and/or edit information for items and/or services ordered by user 104. For example, sales application 112 may be implemented as an application having a user interface enabling mobile merchant 102 to enter payment information and request payment for a payment amount of one or more items/services ordered by user 104. In certain embodiments, sales application 112 may correspond more generally to a web browser configured to view information available over the Internet or access a website corresponding to mobile merchant 102 and/or payment provider server 150. Sales application 112 may receive sales information about the ordered items for user 104 from a server or other device corresponding to mobile merchant 102 (e.g., from a store or central sales location), or the sales information may be entered by mobile merchant 102.

Thus, sales application 112 may correspond to an application providing an interface for mobile merchant 102 to review an order by user 104. The order may include items and/or services requested to be delivered to a location of user 104 by mobile merchant 102. Additionally, sales application 112 may display information for user 104, such as an address, name, or other user information. Sales application 112 may further display the purchase amount for the requested items and/or services, as well as taxes, delivery fees, required tip amount, etc. In certain embodiments, a tip amount may be entered by user 104 with mobile merchant 102 (e.g., when accepting delivery of the items). In other embodiments, user 104 may utilize user device 140 to enter the tip amount, as will be explained in more detail herein. Once check-in application 120 has completed a check-in with home location beacon 130, sales application 112 may display further information received from home location beacon 130 and/or user device 140, including proximity to home location beacon 130, to assist mobile merchant 102 in locating user 104 in an apartment building or close living quarters. For example, sales application 112 may display a picture of user 104 and/or a location corresponding to user 104 (e.g., a home location), instructions for mobile merchant 102 from user 104 (e.g., where to leave items if user 104 is not home, and/or information of another person accepting delivery for the items/services, a gate/door code, parking information, etc.). Thus, in certain embodiments, sales application 112 may include photo-viewing and/or map features.

A payment amount (e.g., a price for the items/services delivered by mobile merchant 110) displayed in sales application 112 may be pushed to user device 140 for viewing by user 104. Once user 104 views the payment amount, user 104 may utilize user device 140 to generate and complete a payment request for the payment amount, including a tip amount in certain embodiments. The payment amount may be pushed to home location beacon 130 for transmission to user device 140, or mobile merchant 102 may request a server/device corresponding to a merchant location for mobile merchant 102 transmit the payment amount to user device 140 (e.g., a merchant server or payment provider server 150). In various embodiments, home location beacon 130 may transmit the payment amount to user device 140 through a wired or short range wireless connection with user device 140, or through a network connection with user device 140, as will be explained in more detail with respect to home location beacon 130.

Sales application 112 may receive a payment token from user device 140 for the amount of the payment amount. The payment token may include a payment request issued by user 104 to mobile merchant 102. The payment request may include a request to pay the payment amount to mobile merchant 102 using a payment instrument identified in the payment token (e.g., using a payment card, payment account with payment provider server 150, etc.). Utilizing the payment token received from user device 140, sales application 112 may submit the payment token to payment provider server 150 for completion of the payment request. The submission to payment provider server 150 may include identification (e.g., an account identifier) of a payment account for mobile merchant 102 to receive payment for the delivered items/services. In other embodiments, however, user device 140 may transmit the payment request to payment provider server 150 with an identifier for mobile merchant 102. Thus, sales application 112 may receive a confirmation of completion of payment from payment provider server 150.

Sales application 112 may access financial information, such as a payment account, bank account, or other financial account that is set up to receive payment for the item/service. Such information may be pushed to user device 140 as well. Thus, sales application 112 may be utilized to complete a payment request for a payment amount between merchant device 110 and payment provider server 150. In various embodiments, a transaction history documenting completion of the transaction may be generated and displayed in sales application 112. For example, payment provider server 150 may transmit a receipt to merchant device 110 and/or user device 140. The transaction history may also be pushed to user device 140 by merchant device 110 if user device 140 has not received the transaction history. Sales application 112 may further include options to store transaction history for purchased items and/or services for later use.

In various embodiments, one or more features of check-in application 120 and/or sales application 112 may be incorporated in the same application so as to provide their respective features in one application.

Merchant device 110 includes other applications 114 as may be desired in particular embodiments to provide features to merchant device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with payment provider server 150. Other applications 114 may include browser and/or mapping applications where the functions are not provided by check-in application 120 and/or sales application 112. Other applications 114 may contain software programs, executable by a processor, including a graphical user interface (GUI) configured to provide an interface to the user.

Merchant device 110 may further include database 116 which may include, for example, identifiers such as operating system registry entries, cookies associated with check-in application 120, sales application 112, and/or other applications 114, identifiers associated with hardware of merchant device 110, or other appropriate identifiers, such as identifiers used for payment/user/device authentication or identification. Identifiers in database 116 may be used by a payment/credit provider, such as payment provider server 150, to associate merchant device 110 with a particular account maintained by the payment/credit provider. Database 116 may include user device tokens and/or encryption keys, including an encryption key of home location beacon 130, user device 140, and/or payment provider server 150. Database 116 may include identifying information for tokens enabling check-in application 120 to identify home location beacon 130, user device 140, and/or payment provider server 150 when receiving a corresponding check-in token.

Database 116 may further include information for use in completing a sale transaction for items and/or services delivered to user 104. For example, database 116 may include items and/or services requested by user 104, the items and/or services payment information, etc. Database 116 may include identification information for user 104, including a name, address, and/or image of user 104. Information in database 116 may be used by mobile merchant to locate and deliver the items and/or services requested by user 104.

Merchant device 110 includes at least one communication module 118 adapted to communicate with home location beacon 130, user device 140, and/or payment provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with home location beacon 130 using short range communications, such as radio frequency, infrared, Bluetooth, and near field communications. Additionally, communication module 118 may communicate with user device 140 through short range wireless communications and/or through a connection to home location beacon 130.

Home location beacon 130 may be maintained, for example, by user 104 and/or payment provider server 150. Home location beacon 130 may be implemented using any appropriate hardware and software configured for wireless communication with merchant device 110. For example, in one embodiment, home location beacon 130 may be implemented as a dongle device including a hardware processor and a communication module, for example, connected to device at the location of user 104. Home location beacon 130 may also be implemented as a device incorporated within a personal computer (PC), a smart phone, laptop computer, and/or other types of computing devices capable of transmitting and/or receiving data, such as an IPAD® from APPLE®. Home location beacon 130 may also act as a stand-alone device including a processor, communication module, and/or network interface component configured to communicate with merchant device 110 and/or payment provider server 150. Although a single beacon is described, a plurality of wireless beacons may be utilized at the location corresponding to user 104.

Home location beacon 130 may be located at a physical location corresponding to user 104. A physical location corresponding to user 104 may constitute a home location, a work location, an office, or other location associated with user 104. Home location beacon 130 of FIG. 1 contains processes, procedures, and/or applications executable by a hardware processor, for example, a software program, configured to interact with merchant device 110, user device 140, and/or payment provider server 150. Thus, regardless of the implementation of home location beacon 130, as discussed above, home location beacon 130 utilizes a check-in application 132 and a communication module 134. In other embodiments, home location beacon 130 may include additional or different software and devices as required.

Check-in application 132 may correspond to an application for transmitting requests to establish a connection between a device (e.g., merchant device 110) and home location beacon 130. Thus, home location beacon 130 may utilize short range wireless communications of home location beacon 130 to transmit the requests to establish a connection, including an identifier such as a Universally Unique Identifier (UUID). If merchant device 110 receives a request to establish the connection with home location beacon 130 and responds with a user device identifier (potentially including the UUID and other information necessary to effectuate a check-in of merchant device 110), check-in application 132 may cause home location beacon 130 to ramp up in power and create a connection between merchant device 110 and home location beacon 130.

Home location beacon 130 may transmit the request to establish the connection with home location beacon 130 as a short range wireless communication (e.g. a BLE protocol communication) including a “wake up” process for check-in application 120 of merchant device 110 and/or a token for home location beacon 130. In other embodiments, the request and/or connection may utilize near field communication, radio communication, infrared communication, Bluetooth communication, or WiFi communication. For example, certain embodiments may utilize a WiFi router or other wireless Internet router as home location beacon 130 that may provide communication services with merchant device 110. Additionally, although home location beacon 130 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to home location beacon 130 (e.g., user device 110) and establishment of a connection for data transfers.

The request may be specific to merchant device 110 by including information that is specific to mobile merchant 102, such as a name, identifier, or user device identifier. The information specific to mobile merchant 102 may be determined from a user account of mobile merchant 102 or other information previously provided to payment provider server 150. Thus, in certain embodiments, only merchant device 110 will pick up and authenticate the request.

After check-in application 132 receives a user device identifier from merchant device 110, check-in application 132 may determine mobile merchant 102 is in proximity to home location beacon 130. Home location beacon 130 may pass the user device identifier to payment provider server 150 to complete the check-in process. As shown in FIG. 1, home location beacon 130 may utilize communication module 134 to pass the identifier to user device 140, which may then pass the identifier to payment provider server 150. However, in other embodiments, home location beacon 130 may utilize a network connection of home location beacon 130 to pass the identifier to payment provider server 150 directly. Additionally, check-in application 132 may cause home location beacon 130 to keep a communication channel open between merchant device 110, user device 140, and/or payment provider server 150 for passing additional information, such as identification sale transaction, payment amount, payment request, and/or transaction history information.

In various embodiments, home location beacon 130 includes at least one communication module 134 adapted to communicate with merchant device 110, user device 140, and/or payment provider server 150. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 134 may communicate with merchant device 110 and/or user device 140 using short range communications, such as radio frequency, infrared, Bluetooth, and near field communications.

User device 140 may be implemented using any appropriate hardware and software configured for wired and/or wireless communication with merchant device 110, home location beacon 130, and/or payment provider server 150. For example, user device 140 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 140 of FIG. 1 contains a payment application 142, other applications 144, a database 146, and a network interface component 148. Payment application 142 and other applications 144 may correspond to processes, procedures, and/or applications executable by a hardware processor, for example, a software program. In other embodiments, user device 140 may include additional or different software as required.

Payment application 142 may be used, for example, to provide a convenient interface to permit user 104 to select payment options and provide payment for items and/or services delivered to a location corresponding to user 104 by mobile merchant 102. For example, payment application 142 may be implemented as an application having a user interface enabling the user to enter payment options for storage by user device 140, provide payment to mobile merchant 102, and complete a transaction for the items and/or services with mobile merchant 102 and/or payment provider server 150. In certain embodiments, payment application 142 may correspond more generally to a web browser configured to view information available over the Internet or access a website corresponding to a payment provider.

Payment application 142 may receive the payment amount for the items and/or services delivered by mobile merchant 102. As previously discussed, the payment amount may be pushed to user device 140 by merchant device 110 either directly or through home location beacon 130. In other embodiments, user device 140 may receive the payment amount from payment provider server 150. Once the payment amount is displayed to user 104 through an application interface for payment application 142, user 104 may view and generate a payment request for the payment amount to mobile merchant 102. The payment request may further include a tip amount added by user 104. The payment request may correspond to a token including a payment instrument of user 104. The payment instrument may include an account identifier, payment card, bank account, etc. Once the payment request is generated, user 104 may authorize the payment request for transmission to payment provider server 150 in order to effectuate a payment to mobile merchant 102. User device 140 may transmit the payment request to payment provider server 150 with an identifier for mobile merchant 102 in order to complete the payment to mobile merchant 102. In other embodiments, payment application 142 may transmit the payment request as a token with a payment instrument and identifier for user 104 to merchant device 110 for completion by merchant device 110.

Payment application 142 may utilize user financial information, such as a credit card, bank account, or other financial account. Additionally, payment application 142 may provide payment for items using a user account with the payment provider, such as payment provider server 150. Payment application 142 may include cross-linking, allowing user 104 to identify a user account through an identifier for a separate user account (e.g. identifying a user account through a debit card account number and vice versa). Payment application 142 may further include options to store transaction histories for purchased items, such as receipts, for later use. Thus, payment application 142 provides an interface enabling user 104 to provide proof of purchase of an item to a merchant.

User device 140 includes other applications 144 as may be desired in particular embodiments to provide features to user device 140. For example, other applications 144 may include security applications for implementing client-side security features, programmatic client applications for interfacing with appropriate application programming interfaces (APIs) over network 170, or other types of applications. Other applications 144 may also include email, texting, voice and IM applications that allow a user to send and receive emails, calls, texts, and other notifications through network 170. In various embodiments, other applications 144 may include financial applications, such as banking, online payments, money transfer, or other applications associated with payment provider server 150. Additionally, other application may include browser applications, social media applications, and/or mapping/check-in applications where not provided by payment application 142. Other applications 144 may contain other software programs, executable by a processor, including a graphical user interface (GUI) configured to provide an interface to the user.

User device 140 may further include database 146 which may include, for example, identifiers such as operating system registry entries, cookies associated with payment application 142 and/or other applications 144, identifiers associated with hardware of user device 140, or other appropriate identifiers, such as identifiers used for payment/user/device authentication or identification. In one embodiment, identifiers in database 146 may be used by payment provider server 150 to associate user device 140 with a particular account maintained by payment provider server 150. Database 146 may also store merchant information, including an identifier for mobile merchant 102. Database 146 may include transaction histories usable to present proof of purchase. Database 146 may include information used by payment application 142, for example, user personal information (e.g. a name, social security number, user financial information, or other identifying information), a user account identifier (e.g. user account identifier is at least one of a user identifier, a user credit or debit card number, a user account name, and a user account number), etc. In various embodiments, database 116 may include online account access information.

User device 140 includes at least one communication module 148 adapted to communicate with merchant device 110, home location beacon 130, and/or payment provider server 150. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 148 may communicate directly with home location beacon 130 using short range communications, such as radio frequency, infrared, Bluetooth, and near field communications. Additionally, communication module 148 may communicate with merchant device 110 through short range wireless communications and/or through home location beacon 130.

Payment provider server 150 may be maintained, for example, by an online payment service provider, which may provide payment services and/or processing for financial transactions on behalf of a user. In this regard, payment provider server 150 includes one or more processing applications which may be configured to interact with merchant device 110, home location beacon 130, and/or user device 140 to facilitate payment for a transaction. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to mobile merchant 102 and/or user 104.

Payment provider server 150 of FIG. 1 includes a check-in application 160, a transaction processing application 152, other applications 154, a database 156, and a network interface component 158. Check-in application 160, transaction processing application 152, and other applications 154 may correspond to processes, procedures, and/or applications executable by a hardware processor, for example, a software program. In other embodiments, payment provider server 150 may include additional or different software as required.

Check-in application 160 may correspond to processes to complete check-in with merchant device 110 for a location corresponding to user 104 (e.g., with home location beacon 130 and user device 140). Thus, check-in application 160 may correspond to the server side application of payment provider server 150 configured to receive a check-in request from merchant device 110 and complete the check-in request. The check-in request may include log in information for a user account in database 156 and thus complete the check-in with mobile merchant 102 by verifying the account information. For example, the check-in information may include an identifier or other account information for a user/payment account of mobile merchant 102 set up to accept payment from user 104. Additionally, the check-in information may include an account identifier for user 104, such as a user/payment account set up to provide payment to mobile merchant 102. However, in embodiments where a user account has not been previously established by mobile merchant 102 and/or user 104, check-in application 152 may receive other information identifying mobile merchant 102 and/or user 104, including a user, name/identifier, user device identifier, an identifier for an account with another server, or other information.

Once check-in is completed between merchant device 110 and home location beacon 130, check-in application 152 may be utilized to transmit and receive information corresponding to user 104. Such information may include identification information for user 104 and/or a location corresponding to user 104, payment information for items/services delivered by mobile merchant 102, and/or identification and payment information for mobile merchant 102. In various embodiments, check-in application 152 and/or information provided to check-in application 152 may be utilized by transaction processing application 152 to provide mobile merchant 102 and/or user 104 with a transaction history documenting payment for the items/services delivered by mobile merchant 102.

Transaction processing application 152 may be configured to receive and/or transmit information from merchant device 110 and/or user device 140 for processing and completion of financial transactions. Transaction processing application 152 may include one or more applications to process financial transaction information from mobile merchant 102 and user 104 by receiving a request to complete transaction for items and/or services delivered by mobile merchant 102. The request may correspond to a payment from user 104 to mobile merchant 102. The payment may include a user account identifier or other payment information (e.g. a credit/debit card or checking account) for user 104 and a receiving account for mobile merchant 102. Additionally, the payment may include a payment amount and terms of payment. Transaction processing application 152 may complete the transaction by providing payment to mobile merchant 102 through the receiving account/payment information. Additionally, transaction processing application 152 may provide transaction histories, including receipts, to merchant device 110 and/or user device 140 for completion and documentation of the financial transaction. For example, a transaction history may be provided to merchant device 110 and/or user device 140 to allow for mobile merchant 102 to view the transaction and provide the items and/or services to user 104.

In various embodiments, one or more features of check-in application 160 and/or transaction processing application 152 may be incorporated in the same application so as to provide their respective features in one application.

In various embodiments, payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 170, or other types of applications. Other applications 154 may contain software programs, executable by a processor, including a graphical user interface (GUI), configured to provide an interface to a user.

Additionally, payment provider server 150 includes database 156. As previously discussed, mobile merchant 102 and/or user 104 may establish one or more user accounts with payment provider server 150. User accounts in database 156 may include merchant/user information, such as name, address, birthdate, payment/funding information, additional user financial information, and/or other desired user data. Mobile merchant 102 and/or user 104 may link to their respective user accounts through a user, merchant, and/or device identifier. Thus, when an identifier is transmitted to payment provider server 150, e.g. from merchant device 110 and/or user device 140, a user account belonging to mobile merchant 102 and/or user 104 may be found. In other embodiments, mobile merchant 102 and/or user 104 may not have previously established a user account and may provide other financial information to payment provider server 150 to complete financial transactions, as previously discussed.

In various embodiments, payment provider server 150 includes at least one network interface component 158 adapted to communicate merchant device 110, home location beacon 130, and/or user device 140 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

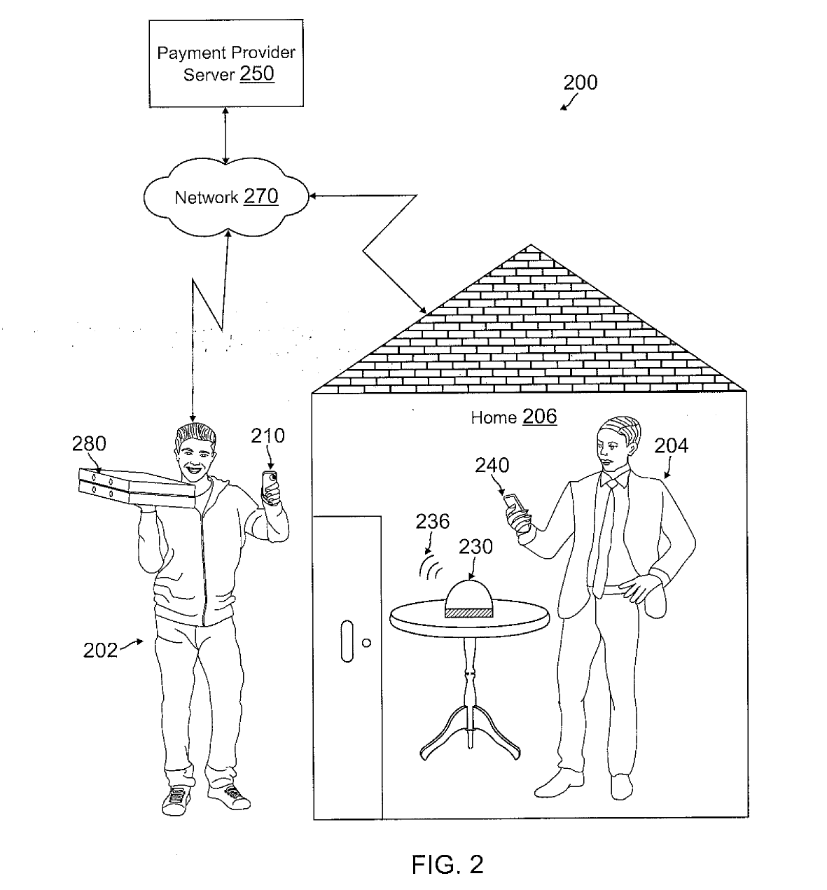

FIG. 2 is an exemplary system environment displaying a mobile merchant checking in to a home location of a user, according to an embodiment. Environment 200 of FIG. 2 includes a mobile merchant 202 and a user 204 corresponding generally to mobile merchant 102 and user 104, respectively, of FIG. 1. Moreover, environment 200 includes a merchant device 210, a home location beacon 230, a user device 240, a payment provider server 250 and a network 270 corresponding generally to merchant device 110, home location beacon 130, user device 140, payment provider server 150 and network 170, respectively, of FIG. 1.

Environment 200 shows user 204 located at a home 206 where user 204 has requested items and/or services to be delivered by mobile merchant 202. Thus, mobile merchant 202 is in possession of an item 280. Item 280 may correspond to some good (e.g., food, delivery items, etc.) or service (e.g., cleaning services, plumbing, etc.) that mobile merchant 202 is bringing to home 206 for delivery to user 204. When mobile merchant 202 arrives at home 206 with merchant device 210, mobile merchant may be checked-in to home 206 through home location beacon 230. For example, merchant device 210 may execute a check-in application either on instruction by mobile merchant 202 when arriving at or near home 206 or the check-in application may execute in the background of merchant device 210 and passively scan for beacons emitting a check-in token (e.g., a request through a communication protocol such as Bluetooth Low Energy). Thus, as home location beacon 230 emits a check-in token 236, merchant device 210 may receive check-in token 236 and ramp up in power to complete a check-in with payment provider server 250.

Once merchant device 210 has received check-in token 236, the check-in application executing on merchant device 210 may complete a check-in process, discussed in reference to FIG. 1. Once a check-in is completed for mobile merchant 210 with home 206, user 204 may receive a notification that mobile merchant 202 has checked-in using home location beacon 230 on user device 240. Additionally, user device 240 may display identification information for mobile merchant 202 and/or a payment amount of item 280 with mobile merchant 202. Mobile merchant 202 may push this information to user device 240 through home location beacon 230. However, in other embodiments, user device 240 may receive this information for a server corresponding to mobile merchant 202 and/or payment provider server 250 after a request to transmit the payment information is initiated by mobile merchant 202.

User 204 may view the payment amount and generate a payment request for the payment amount. The payment request may further include a tip amount to mobile merchant 202. The payment request may be included in a token transmitted to payment provider server 250 over network 270. Thus, the payment token may identify mobile merchant 202 and correspond to a request to pay the payment amount (and tip amount) to a payment account of mobile merchant 202. In other embodiments, the payment token may be transmitted to merchant device 210, such as through home location beacon 230, where mobile merchant 202 submits the payment token to payment provider server 250 over network 270. Once user 204 has completed payment to mobile merchant 202, mobile merchant 202 may provide item 280 to user 204. However, in other embodiments, user 204 may not physically be located at home 206 when the items and/or services are delivered by mobile merchant 202. Thus, mobile merchant 202 may provide the items to another user at home 206 (e.g., a family member, roommate, friend, babysitter, etc.), or mobile merchant 202 may leave item 280 at home 206 on instructions transmitted to mobile merchant 202 from home location beacon 230 and/or user device 240 (e.g., over network 270 with merchant device 210).

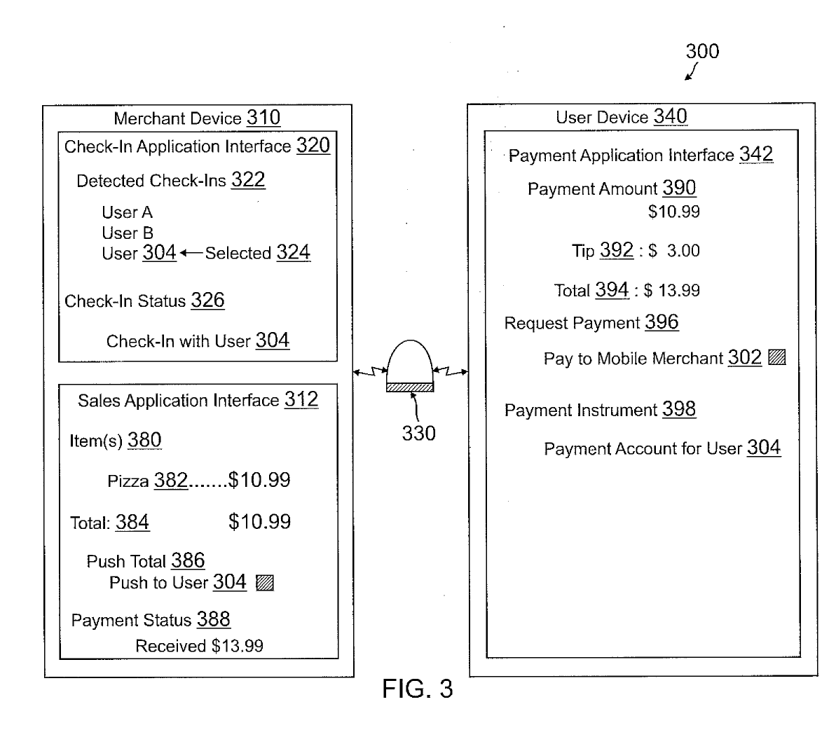

FIG. 3 is an exemplary system environment showing display screens of a user device and a merchant device after check-in at a home location of a user, according to an embodiment. Environment 300 includes a merchant device 310, a home location beacon 330, and a user device 340 corresponding generally to merchant device 110, home location beacon 130, and user device 140, respectively, of FIG. 1.

Merchant device 310 displays a check-in application interface 320 having similar executed features and processes discussed in reference to check-in application 120 of FIG. 1. Check-in application interface 310 displays detected check-ins 322 having a list of received check-in tokens from one or more wireless beacons. Thus, detected check-ins 322 includes user A, user B, and user 304. Thus, a mobile merchant (not shown) utilizing merchant device 310 may select a user to check-in to by identifying the user in the list and choosing to check-in to that user's location. However, in other embodiments, merchant device 310 may automatically check-in to one of the users, for example, if only one check-in token is received or if merchant device 310 has information identifying one of the users for check-in and their respective token. The check-in tokens may be received from home location beacon 330.

As shown in check-in application interface 320, user 304 has been selected for check in through selected highlight 324. Thus, merchant device 310 may execute a process to check-in merchant device 310, and thus the mobile merchant, with a location corresponding to home location beacon 330. Once checked-in with the location corresponding to home location beacon 330, check-in application interface 320 displays a check-in status 326. Thus, check-in status 326 displays “checked-in with user 304.”

After completion of the check-in, the mobile merchant may utilize a sales application interface 312 to push a payment amount to user device 340 (e.g., through home location beacon 330) and view if the payment amount has been paid to the mobile merchant. Sales application interface 312 may display similar executed features and processes discussed in reference to sales application 112 of FIG. 1. Sales application interface includes item(s) 380 corresponding to ordered items by a user of user device 340. Item(s) 380 includes a pizza 382 with a corresponding price of $10.99. Thus, total 382 displays $10.99. In other embodiments, additional amounts may be added to total 384, such as a delivery surcharge, tax, tip, etc. The mobile merchant may use sales application interface 312 to transmit total 382 to user device 340 by selecting a push total 386 option. Thus, under push total 386, sales application interface 312 displays that total 384 was pushed to user 304 (e.g., to user device 340 through home location beacon 330.

User device 340 displays a payment application interface 342 having similar executed features and processes discussed in reference to payment application 142 of FIG. 1. Payment application interface 342 includes a payment amount 390 corresponding to total 384 transmitted to user device 340 from merchant device 310. Under payment amount 390 is a tip 392 of $3.00 corresponding to an additional amount provided by the user of user device 340 and added to payment amount 390. Thus, total 394 includes both payment amount 390 and tip 392 and may be used to generate a payment request to the mobile merchant for total 394. The user of user device 340 may select request payment 396 to transmit the payment request to a payment provider. Thus, as shown under request payment 396, the user has instructed the payment provider to “pay to mobile merchant 302.”

Payment application interface 342 may further include processes to allow the user of user device 340 to select a payment card, payment account, bank account, etc., for use in paying the mobile merchant. Therefore, payment instrument 398 may allow the user to select a payment instrument. As shown in payment application interface 342, the user has selected to pay using a payment account for user 304 with a payment provider. Once the payment request is transmitted and approved, sales application interface 312 of merchant device 310 may update a payment status 388 to display whether the user has paid and the amount the user has paid. Thus, in FIG. 3 payment status 388 updates to “received $13.99.”

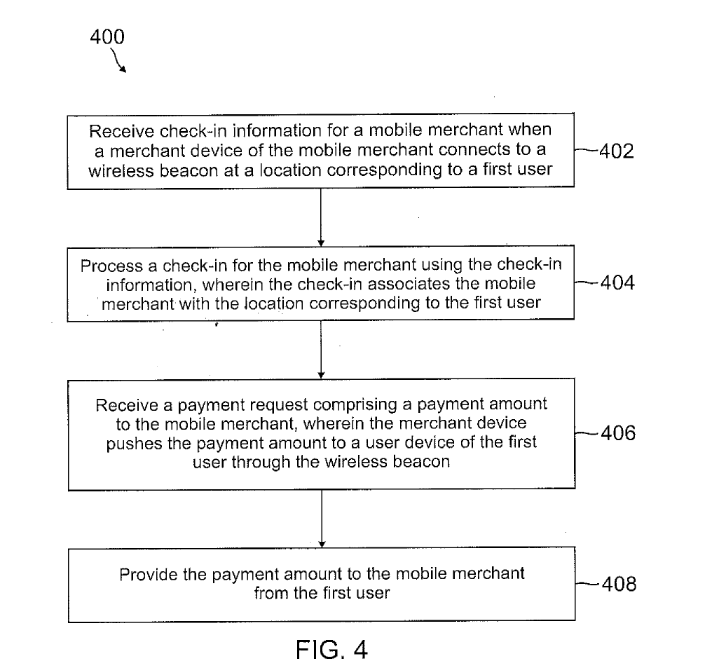

FIG. 4 is a flowchart of an exemplary process by a server for mobile merchant check-in at a user's home location, according to an embodiment. Note that one or more steps, processes, and methods described herein may be omitted, performed in a different sequence, or combined as desired or appropriate.

At step 402, check-in information for a mobile merchant is received when a merchant device of the mobile merchant connects to a wireless beacon at a location corresponding to a first user. The merchant device and the wireless beacon may connect using one of near field communication, radio communication, infrared communication, Bluetooth communication, and Bluetooth low energy communication. Additionally, the location corresponding to the first user may comprise a home location for the first user, and the mobile merchant may comprise a delivery person for a merchant.

The wireless beacon may be range limited to connect to the merchant device within a set distance outside the home location. Thus, the first user may adjust the set distance for the wireless beacon. In certain embodiments, the first user may not be at the home location. Thus, the wireless beacon may alert the first user of an arrival of the mobile merchant over a network connection. In such embodiments, the first user may alert a second user at the home location of the arrival of the mobile merchant using the user device. For example, the first user may alert the second user by providing an identifier (e.g., a device identifier, phone number; email address, etc.) for the second user to a server or the wireless beacon, where the server/wireless beacon transmits a notification to the second user corresponding to the arrival of the mobile merchant at the home location.

At step 404, a check-in for the mobile merchant is completed using the check-in information, wherein the check-in associates the mobile merchant with the location corresponding to the first user. A payment request comprising a payment amount to the mobile merchant is received, at step 406, wherein the merchant device pushes the payment amount to a user device of the first user through the wireless beacon. The wireless beacon may transmit the payment amount to the user device of the first user through short range wireless communications (e.g., BLE communications) or over a network connection with the user device. In various embodiments, the check-in for the mobile merchant may be completed without input by the mobile merchant, and the payment amount may be automatically pushed to the user device after completion of the check-in. The payment request may further comprise a tip amount to the mobile merchant. Thus, the first user may enter the tip amount to the user device prior to the user device transmitting the payment request.

The payment request is completed, at step 408, by providing the payment amount to the mobile merchant from the first user. The mobile merchant may be notified of completion of the payment request. In certain embodiments, delivery instructions may be received from the first user, for example, if the first user is not at the home location. Thus, the delivery instructions may be provided to the mobile merchant through the merchant device.

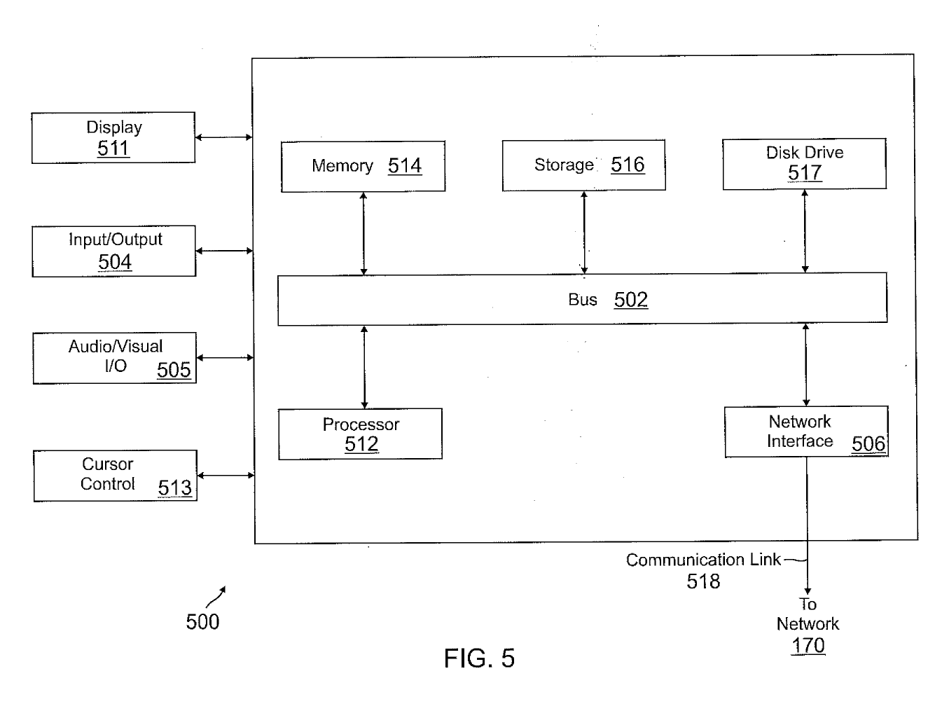

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing check-in information for a mobile merchant; and
one or more hardware processors in communication with the non-transitory memory and configured to:
receive the check-in information for the mobile merchant when a merchant device of the mobile merchant connects to a wireless beacon at a location corresponding to a first user;
process a check-in for the mobile merchant using the check-in information, wherein the check-in associates the mobile merchant with the location corresponding to the first user;
receive a payment request comprising a payment amount to the mobile merchant, wherein the merchant device pushes the payment amount to a user device of the first user through the wireless beacon; and
provide the payment amount to the mobile merchant from the first user.

2. The system of claim 1, wherein the merchant device and the wireless beacon connect using one of near field communication, radio communication, infrared communication, Bluetooth communication, Bluetooth low energy communication, LTE Direct communication, and WiFi communication.

3. The system of claim 1, wherein the location corresponding to the first user comprises a home location for the first user, and wherein the mobile merchant comprises a delivery person for a merchant.

4. The system of claim 3, wherein the wireless beacon is range limited to connect to the merchant device within a set distance outside the home location.

5. The system of claim 4, wherein the first user adjusts the set distance.

6. The system of claim 3, wherein the first user is not at the home location, and wherein the wireless beacon alerts the first user of an arrival of the mobile merchant over a network connection.

7. The system of claim 1; wherein the payment request further comprises a tip amount to the mobile merchant, and wherein the one or more hardware processors are further configured to:
provide the tip amount to the mobile merchant from the first user.

8. A method comprising:
receiving check-in information for a mobile merchant when a merchant device of the mobile merchant connects to a wireless beacon at a location corresponding to a first user;
associating the mobile merchant with the location corresponding to the first user using the check-in information;
receiving a payment request comprising a payment amount to the mobile merchant, wherein the merchant device pushes the payment amount to a user device of the first user through the wireless beacon; and
processing the payment request to the mobile merchant from the first user.

9. The method of claim 8, wherein the location corresponding to the first user comprises a home location for the first user, and wherein the mobile merchant comprises a delivery person for a merchant.

10. The method of claim 9, wherein the first user is not at the home location, and wherein the wireless beacon alerts the first user of an arrival of the mobile merchant over a network connection.

11. The method of claim 10, wherein the first user alerts a second user at the home location of the arrival of the mobile merchant using the user device.

12. The method of claim 11, wherein the first user alerts the second user by providing an identifier of the second user, and wherein the method further comprises:
transmitting a notification to the second user corresponding to the arrival of the mobile merchant at the home location.

13. The method of claim 8 further comprising:
notifying the mobile merchant of the completing the payment request.

14. The method of claim 8, wherein the payment request further comprises a tip amount to the mobile merchant.

15. The method of claim 14, wherein the first user enters the tip amount to the user device prior to the user device transmitting the payment request.

16. A non-transitory computer-readable medium comprising instructions which, in response to execution by a computer system, cause the computer system to perform a method comprising:
receiving check-in information for a mobile merchant when a merchant device of the mobile merchant transmits a payment amount to a wireless beacon at a location corresponding to a first user;
associating the mobile merchant with the location corresponding to the first user using the check-in information;
receiving a payment request comprising the payment amount to the mobile merchant from a user device of the first user after the user device receives the payment amount from the wireless beacon; and
processing the payment request to the mobile merchant from the first user.

17. The non-transitory computer-readable medium of claim 16, wherein the location corresponding to the first user comprises a home location for the first user, and wherein the mobile merchant comprises a delivery person for a merchant.

18. The non-transitory computer-readable medium of claim 16, wherein the payment request further comprises a tip amount to the mobile merchant.

19. The non-transitory computer-readable medium of claim 16, wherein the method further comprises:
receiving delivery instructions from the first user; and
providing the delivery instructions to the mobile merchant through the merchant device.

20. The non-transitory computer-readable medium of claim 16, wherein the check-in information for the mobile merchant is received without input by the mobile merchant, and wherein the merchant device automatically transmits the payment amount to the wireless beacon.
